(19) United States
(12) Patent Application Publication
(10) Pub. No.: US 2008/0132258 A1
(43) Pub. Date: Jun. 5, 2008

(54) METHOD AND APPARATUS FOR BARRING SHORT MESSAGES

(75) Inventors: Shih-Chan Hsu, Yongkang City (TW); Hai-Ti Hsu, Taipei City (TW); Yi-Chia Chiang, Taipei City (TW)

Correspondence Address: SNELL & WILMER L.L.P. (Main), 400 EAST VAN BUREN, ONE ARIZONA CENTER, PHOENIX, AZ, 85004-2202, US

(73) Assignee: BENQ CORPORATION, Taoyuan (TW)

(21) Appl. No.: 11/772,978

(22) Filed: Jul. 3, 2007

(30) Foreign Application Priority Data
Jul. 4, 2006 (TW) 95124409

(51) Int. Cl. H04Q 7/20

(52) U.S. Cl. 455/466

(57) ABSTRACT

A method for barring short messages and a mobile device which utilizes the same are provided. The mobile device is configured to receive a plurality of short messages from a message center, and includes a storage unit for storing short messages. The method of the present invention includes the following steps: providing an option of barring short messages in a Man/Machine Interface of the mobile device; enabling the option of barring short messages; and transmitting a first signal to the message center when the amount of storage data in the storage unit is lower than a predetermined value, so that the message center stores a plurality of first short messages which are intended to be transmitted to the mobile device.

### CROSS-REFERENCE TO RELATED APPLICATIONS

This application claims the right of priority based on Taiwan Patent Application No. 95124409 entitled “METHOD AND APPARATUS FOR BARRING SHORT MESSAGES,” filed on Jul. 4, 2006, which is incorporated herein by reference and assigned to the assignee herein.

### TECHNICAL FIELD

The present invention relates to a method and an apparatus for barring short messages, and more particularly to a method and an apparatus for barring short messages based on a use's decision.

### BACKGROUND OF THE INVENTION

As the technology of mobile communication develops and propagates, the mobile phones or other mobile devices have been indispensable to people. And it is more and more common to communicate or convey information by sending short messages. Presently, the short message service (SMS) for sending text messages is one of the most familiar mobile communication services. Besides, the multimedia message service (MMS) for sending multimedia messages is more and more popular among the consumers. The short message services may work in conjunction with the internet for the users to send short messages to the mobile devices through the internet.

However, the more versatile the applications of short messages are, the more possible it is for spam messages to be used. The users have no other choices but receiving all the short messages until out of the storage in mobile phone. If the user would not like to receive any short messages, according to the prior art, the only way is to ask the customer service staff of the network operator to disable the message service. And if the user would like to receive the messages afterward, he/she has to ask the staff to enable the message service. The entire procedure is inconvenient and time-consuming for the users, and may even result in more cost.

Consequently, it is necessary to provide a method and an apparatus for rapidly barring short messages based on the user's decision.

### SUMMARY OF THE INVENTION

In light of the problems of the prior art, the present invention provides a method and an apparatus for barring short messages in which the users may decide to bar or not.

According to one aspect of the present invention, a method applied to a mobile device for barring short messages is provided. The mobile device is configured to receive a plurality of short messages from a message center, and includes a storage unit. The method includes the following steps: providing an option of barring short messages in a Man/Machine Interface of the mobile device; enabling the option of barring the short messages; and transmitting a first signal to the message center when the amount of storage data in the storage unit is lower than a predetermined value, so that the message center stores a plurality of first short messages which are intended to be transmitted to the mobile device.

According to another aspect of the present invention, a mobile device for receiving a plurality of first short messages from a message center is provided. The mobile device includes a storage unit for storing different data and a Man/Machine Interface including an option of barring short messages. The mobile device transmits a first signal to the message center when the option of barring short messages is enabled and the amount of storage data in the storage unit is lower than a predetermined value, so that the message center stores a plurality of first short messages which are intended to be transmitted to the mobile device.

The objects, embodiments, features and advantages of the present invention will become more apparent by referring to the following description of the preferred embodiments and the drawings.

### BRIEF DESCRIPTION OF THE DRAWINGS

FIG. 1 illustrates a mobile device capable of barring short messages according to the present invention; and

FIG. 2 is a flow chart of a method for barring short messages according to the present invention.

### DETAILED DESCRIPTION OF THE PREFERRED EMBODIMENTS

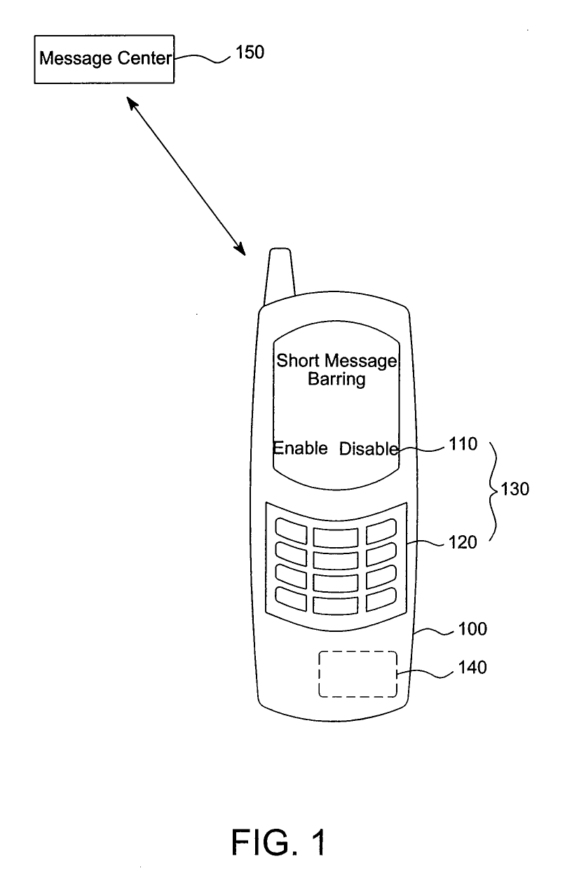

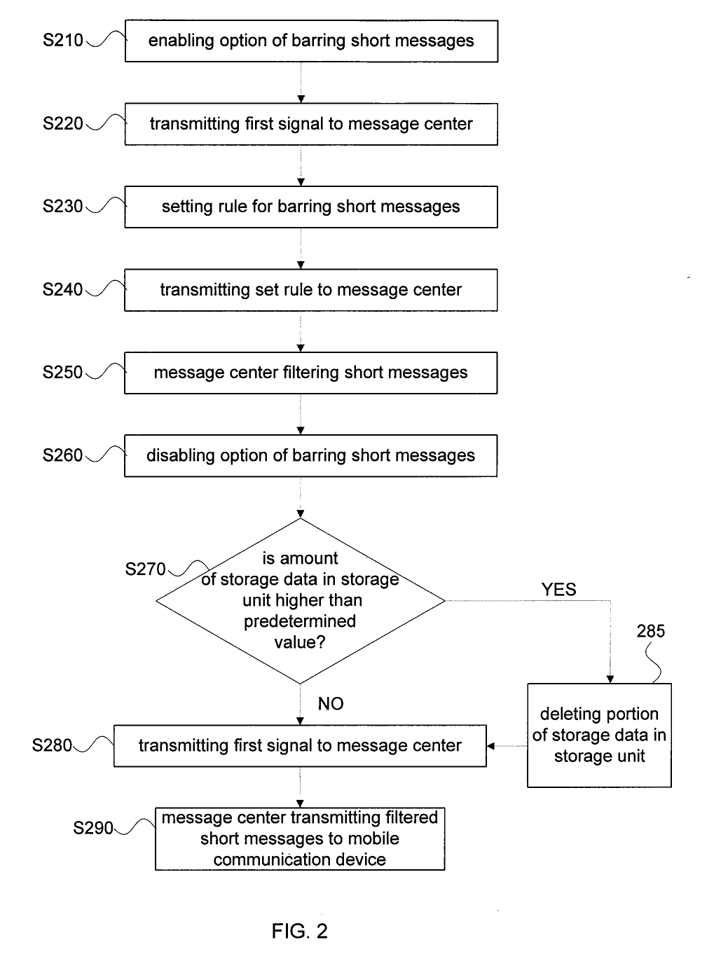

A method and an apparatus for barring short messages are disclosed in the present invention. To make the disclosure of the present invention more detailed and complete, references are made to the following description in conjunction with FIGS. 1 and 2. Nevertheless, the apparatus, elements and steps of the method described in the following embodiments are only for illustration, and are not to limit the scope of the present invention.

FIG. 1 illustrates a mobile device 100 capable of barring short messages according to the present invention. The mobile device 100 is capable of receiving short messages, including text messages or multimedia messages, from the message center 150. The mobile device 100 includes a storage unit 140 for storing received short messages, and a Man/Machine Interface 130 including of a display 110 and keys 120. Besides short messages, the storage unit 140 may store various data, such as a phone book or photo files.

Generally, the mobile device 100 transmits a first signal to the message center 150 when the amount of storage data in the storage unit 140 is higher than a predetermined value, so as to request the message center 150 not to send any more short messages to the mobile device 100. At this stage, any short messages intended to be transmitted to the mobile device 100 are temporarily stored in the message center 150. The user may delete a portion of stored short messages or other data and reduce the amount of storage data in the storage unit 140 to be lower than the predetermined value. Then the mobile device 100 may transmit a second signal to request the message center 150 to transmit short messages to it again.

As shown in FIG. 1, the Man/Machine Interface 130 of the mobile device 100 provides an option of barring short message for the user to enable or disable the function of barring short messages. The present invention enables or disables the function of barring short messages by transmitting a signal indicating the amount of storage data in the storage unit 140 being higher or lower than the predetermined value. In other words, as the user operates the MMI and enables the function of barring short messages, the mobile device 100 immediately transmits a first signal to the message center 150, which is configured to inform the message center 150 that the amount of storage data in the storage unit 140 is higher than the predetermined value. However, the amount of storage data in the storage unit 140 may truly be higher than the predetermined value or actually be lower than the predetermined value. After receiving the first signal, the message center 150 stores any short messages intended to be transmitted to the mobile device 100 and sends no more short messages to the mobile device 100.

If the user disables the function of barring short messages and the amount of storage data in the storage unit 140 is lower than the predetermined value, the mobile device 100 transmits a second signal to the message center 150, which indicates the amount of storage data in the storage unit 140 is lower than the predetermined value. Then, the message center 150 can transmit the stored short messages to the mobile device 100. However, if the amount of storage data in the storage unit 140 is higher than the predetermined value, the mobile device 100 does not transmit the second signal to the message center 150 as the user disables the function of barring short messages. The mobile device 100 transmits the second signal to the message center 150 only if the user deletes a portion of storage data to make the amount of storage data in the storage unit 140 lower than the predetermined value.

In another embodiment of the present invention, the Man/Machine Interface 130 of the mobile device 100 may be utilized to set a rule for barring short messages, for example, barring short messages from certain phone numbers or short messages including certain text. When the mobile device 100 enables the function of barring short messages, the message center 150 stores the short messages intended to be transmitted to the mobile device 100. The mobile device 100 may transmit the rule to the message center 150, so that the message center 150 filters the stored short messages according to the rule, such as deleting the short messages from certain phone numbers or the short messages including certain text. Therefore, the message center 150 will only transmit the filtered short messages to the mobile device 100 when the mobile device 100 disables the function of barring short messages.

The mobile device 100 can bar short messages by enabling the function of barring short messages without influencing the operation of other functions. In addition, the present invention may utilize the existing signals to actively enable or disable the function of barring short messages instead of generating other undefined new signals; thus, not only the design complexity, but the cost are reduced.

FIG. 2 is a flow chart of a method for barring short messages according to the present invention. The method applies to the mobile device shown in FIG. 1, in which the mobile device is configured to receive short messages from a message center, and includes a storage unit for storing short messages and various data. First, in step S210, an option of barring short messages in a Man/Machine Interface of the mobile device is enabled. In step S220, the mobile device transmits a first signal to the message center, which requests the message center to store short messages intended to be transmitted to the mobile device, rather than transmit these short messages. At this time, the amount of storage data in the storage unit may be lower than a predetermined value or higher than the predetermined value.

In step S230, a rule for barring short messages is set through the Man/Machine Interface of the mobile device. For example, the rule may correspond to a phone number or a text message. Next, in step S240, the set rule is transmitted to the message center. In step S250, the message center filters the stored short messages according to the rule, such as deleting short messages corresponding to the phone numbers or text messages in the rule.

If the user wants to regain short message receiving, then the option of barring short messages is disabled in step S260. Next, in step S270, the mobile device decides if the amount of storage data in the storage unit exceeds a predetermined value. If not, the procedure proceeds to step S280, and a second signal indicating the storage unit having space to store short messages is transmitted to the message center. Then, in step S290, the message center transmits the filtered short messages to the mobile device after receiving the second signal. If the mobile device decides that the amount of storage data in the storage unit exceeds the predetermined value, it would not transmit the second signal to the message center. Then the procedure proceeds to step S285, and a portion of data in the storage unit is deleted to reduce the amount of storage data in the storage unit lower than the predetermined value. Once the amount of storage data in the storage unit is lower than the predetermined value, the procedure goes back to steps S280 and S290, and the messages filtered by the message center are transmitted to the mobile device.

The method of the present invention is for barring short messages in which the users may decide to bar or not, while the operation of other functions of the mobile device may not be influenced. Generally, short message receiving may induce sounds from the mobile device or even influence the operation of the mobile device. Such annoyances may be eliminated by the short message barring method of the present invention, and the circulation of the short messages in the mobile network may be reduced. Additionally, receiving short messages by the mobile device in roaming mode may induce extra charge in certain areas or countries, while the method and apparatus of the present invention may help reduce it.

The above description is only for the preferred embodiments of the present invention; it is not to limit the scope of the invention. Any other equivalent changes or modifications without departing from the spirit disclosed by the present invention should be included within the scope of the appended claims.

We claim:

1. A method for barring short messages for a mobile device, the mobile device being configured to receive a plurality of short messages from a message center, the mobile device having a storage unit, the method comprising:
(a) providing an option of barring short messages in a Man/Machine Interface of the mobile device;
(b) enabling the option of barring short messages; and
(c) transmitting a first signal to the message center when an amount of storage data in the storage unit is lower than a predetermined value, wherein the plurality of first short messages to be transmitted to the mobile device are stored in the message center.

2. The method according to claim 1, further comprising:
disabling the option of barring short messages; and
transmitting a second signal to the message center, the message center transmits the plurality of first short messages to the mobile device.

3. The method according to claim 1, further comprising:
setting a rule for barring short messages and transmitting the rule to the message center;
disabling the option of barring short messages;
the message center filtering the stored plurality of first short messages according to the rule and obtaining a plurality of second short messages; and
transmitting a second signal to the message center, the message center transmits the plurality of second short messages to the mobile device.

4. The method according to claim 1, further comprising:
transmitting the first signal to the message center when the amount of storage data in the storage unit is higher than the predetermined value, the message center stores the plurality of first short messages.

5. The method according to claim 4, further comprising:
disabling the option of barring short messages;
deleting a portion of the storage data of the storage unit to reduce the amount of storage data in the storage unit lower than the predetermined value; and
transmitting a second signal to the message center, the message center transmits the plurality of first short messages to the mobile device.

6. The method according to claim 3, wherein the rule corresponds to a phone number, and the method further comprises:
the message center deleting at least one of first short messages corresponding to the phone number from the stored plurality of first short messages.

7. The method according to claim 3, wherein the rule corresponds to a text message, and the method further comprises:
the message center deleting at least one of first short messages containing the text message from the stored plurality of first short messages.

8. The method according to claim 1, wherein the mobile device enables the option of barring short message in a roaming mode.

9. A mobile device for receiving a plurality of first short messages from a message center, the mobile device comprising:
a storage unit with a predetermined value; and
a Man/Machine Interface having an option of barring short messages, wherein the mobile device transmits a first signal to the message center when the option of barring short messages is enabled and an amount of storage data in the storage unit is lower than the predetermined value, the message center storing a plurality of first short messages to be transmitted to the mobile device.

10. The mobile device according to claim 9, wherein when the mobile device transmitting a second signal to the message center when the option of barring short message is disabled, the message center transmits the plurality of first short messages to the mobile device.

11. The mobile device according to claim 9, wherein the Man/Machine Interface is utilized to set a rule for barring short messages, and wherein the mobile device transmits the rule and a second signal to the message center when the option of barring short messages is disabled, wherein the message center filters the stored plurality of first short messages according to the rule and obtains a plurality of second short messages, and transmits the plurality of second short messages to the mobile device according to the second signal.

12. The mobile device according to claim 9, wherein the mobile device transmits the first signal to the message center when the amount of storage data in the storage unit is higher than the predetermined value, so that the message center stores the plurality of first short messages.

13. The mobile device according to claim 12, wherein as the option of barring short messages is disabled and a portion of storage data in the storage unit is deleted to reduce the amount of storage data in the storage unit lower than the predetermined value, the mobile device transmits a second signal to the message center so that the message center transmits the plurality of first short messages to the mobile device.

14. The mobile device according to claim 11, wherein the rule corresponds to a phone number, so that the message center deletes at least one of first short messages corresponding to the phone number from the stored plurality of first short messages.

15. The mobile device according to claim 11, wherein the rule corresponds to a text message, so that the message center deletes at least one of first short messages containing the text message from the stored plurality of first short messages.

16. The mobile device according to claim 9, wherein the mobile device enables the option of barring short message in a roaming mode.

17. A method for barring short messages for a mobile device, the mobile device being configured to receive a plurality of short messages from a message center, and the mobile device including a storage unit, the method comprising:
(a) providing an option of barring short messages in a Man/Machine Interface of the mobile device;
(b) enabling the option of barring short messages; and
(c) transmitting a first signal to the message center, wherein a plurality of first short messages to be transmitted to the mobile device are not transmitted to the mobile device.

18. The method according to claim 17, wherein the first signal is transmitted to the message center when an amount of storage data in the storage unit is lower than a predetermined vale.

19. The method according to claim 17, further comprising:
disabling the option of barring short messages; and
transmitting a second signal to the message center so that the message center transmits the plurality of first short messages to the mobile device.

20. The method according to claim 17, further comprising:
setting a rule for barring short messages and transmitting the rule to the message center;
disabling the option of barring short messages;
the message center filtering the stored plurality of first short messages according to the rule and obtaining a plurality of second short messages; and
transmitting a second signal to the message center so that the message center transmits the plurality of second short messages to the mobile device.
